(19) United States
(12) Patent Application Publication
(10) Pub. No.: US 2021/0316274 A1
(43) Pub. Date: Oct. 14, 2021

(54) ALL-CELLULOSE SUPER ABSORBENT HYDROGELS AND METHOD OF PRODUCING SAME

(71) Applicant: FPInnovations, Pointe-Claire (CA)

(72) Inventors: Wadood Y. HAMAD, Vancouver (CA); Siham ATIFI, Vancouver (CA)

(21) Appl. No.: 17/273,894

(22) PCT Filed: Sep. 6, 2019
(86) PCT No.: PCT/CA2019/051245

§ 371 Date: Mar. 5, 2021

Related U.S. Application Data
(60) Provisional application No. 62/728,180, filed on Sep. 7, 2018.

(51) Int. Cl. B01J 20/24; B01J 20/28; B01J 20/30; C08B 15/00

(52) U.S. Cl. CPC B01J 20/24; B01J 20/28047; B01J 2220/68; C08B 15/005; B01J 20/3085

(57) ABSTRACT

The present disclosure generally relates to a scalable, green process for producing non-toxic, all-cellulose super absorbent hydrogels that form instantly after cross-linking. A super absorbent hydrogel can be produced by physical mixing of water-soluble carboxyalkyl polysaccharides such carboxymethyl cellulose and negatively-charged cellulose nanocrystals resulting in instantaneous gelation. Cellulose nanocrystals act as effective cross-linkers when physically mixed with carboxymethyl cellulose in an aqueous medium. The resulting hydrogel possesses excellent absorption properties, and has applications in a wide range of products from hygiene products to medical and industrial super absorbent products.

### CROSS-REFERENCE TO RELATED APPLICATIONS

The present application claims benefit of U.S. Provisional Application No. 62/728,180 filed Sep. 7, 2018, the content of which is hereby incorporated by reference in its entirety.

### TECHNICAL FIELD

The present disclosure generally relates to cellulose-based superabsorbent hydrogels comprising a non-toxic polysaccharide cross-linked with cellulosic nanoparticles. The polysaccharide is an anionic carboxymethyl cellulose (CMC) and the cellulosic nanoparticles are negatively-charged cellulose nanocrystals (CNCs), the superabsorbent hydrogels exhibiting high free swell capacity.

### BACKGROUND

Superabsorbent articles, also referred to as superabsorbents, are widely used in the hygiene industry and medical applications to absorb and retain liquids, bodily fluids and blood. Superabsorbent articles represent water-swellable, water-insoluble absorbent materials capable of absorbing at least 10, preferably about 20, and sometimes up to about 100 times their weight in saline (0.9% sodium chloride (NaCl)) where the saline solution is the representation of the physiological fluids produced by the human body. The superabsorbent materials absorb liquids rapidly and immobilize them within the molecular structure, thus preventing leakages and providing dry feel.

Most of the current superabsorbent materials used are based on crosslinked synthetic polymers, in particular acrylic acid and its co-polymers with acrylamide. Superabsorbent polymers are formed by either solution polymerization of a partially neutralized acrylic acid or by suspension polymerization. In the solution polymerization, the product is a continuous rubbery gel that is cut, dried and comminuted into desired particle size. In the suspension polymerization, or reversed emulsion polymerization, the water soluble polymer is dispersed in water-immiscible solvent. The products are spherical particles where the size can be controlled by reaction conditions.

Superabsorbent polymers (SAPs) or hydrogels are cross-linked polymer networks that can absorb large amounts of aqueous fluids. This property makes them ideal for use in a variety water absorbing applications such as infant diapers, adult incontinent pads, feminine care products, absorbent medical dressings and the likes. SAPs are mostly derived from cross-linked synthetic polymers and co-polymers such as polyacrylic acid or polyacrylamide which are not renewable materials nor biologically degradable.

According to U.S. Pat. No. 6,765,042, a superabsorbent polysaccharide can be obtained from an acidic polysaccharide including carboxymethyl cellulose, a carboxymethyl starch or a mixture thereof at molecular weight between 1,000 and 25,000. A carboxymethyl cellulose at a molecular weight of 50,000 with a degree of substitution of 0.8 is used and cross-linked with a chemical cross-linking agent such as divinyl sulphone (DVS) or 1,4-butanediol diglycidyl ether (BDDE) to produce a gel. Cross-linking can be done at high temperatures of at least 100° C. in neutral, acidic or alkaline media. The process comprises a further step of contacting the crosslinked polysaccharide with a water-miscible organic solvent (e.g. methanol or ethanol) which is 2-30 times the amount of the gelled polysaccharide, for one week. An additional post-crosslinking step is also applied after comminuting or after drying the gel to strengthen it. The steps involved are complex and require different procedures for final preparation. As such, this method is difficult to scale up into a commercial procedure. According to U.S. Pat. No. 6,765,042, post-crosslinking can be done using the same cross-linking agent used earlier or it may be performed in the presence of bifunctional or multifunctional compounds capable of reacting with hydroxyl and carboxyl functions (e.g. polyamide-amine-epichlorohydrin). The process also includes pH adjusting, drying and comminuting steps. The resultant superabsorbent polysaccharide materials were characterized in synthetic urine as test liquid. Their Free Swell Capacity (FSC) ranges from 21 to 132 g/g, their Centrifugal Retention Capacity (CRC) ranges from 13 to 111 g/g while their Absorption Under Load (AUL) is in the range 10-23 g/g.

U.S. Pat. No. 8,703,645 describes a water-absorbing polysaccharide material based on carboxyalkyl cellulose (e.g. carboxymethyl cellulose) cross-linked with polyphosphate or polyphosphoric acid. The obtained polysaccharide polymer particulates are then surface cross-linked using an acid including phosphoric acid, and lactic acid, or using water soluble multivalent metal salts such as aluminum sulfate. The resulting superabsorbent polymer has a CRC reaching 19.2 g/g, an AUL at 0.9 psi of from about 10 g/g to about 20 g/g with a permeability half-life of between about 30 days and about 180 days.

U.S. Patent Application Publication No. 2008/0262155 A1 describes a method of producing superabsorbent polymers from polycarboxypolysaccharides (e.g. carboxymethyl cellulose). The hydrogel is mechanically comminuted and dried then coated with a solution of a cross-linker (e.g. citric acid monohydrate) and subjected to a surface ionic and/or covalent post cross-linking agents (e.g. aluminum salts, di- and polyamines). The obtained post cross-linked superabsorbent polymer has Absorbency Against Pressure (AAP) value, at 0.7 psi, of 12.5 g/g or more.

U.S. Pat. No. 5,550,189 provides a process for producing a water-swellable, water-insoluble carboxyalkyl polysaccharide having improved absorbent properties. The method is based on forming a homogeneous mixture of carboxyalkyl polysaccharides (e.g. carboxymethyl cellulose), water, and a cross-linking agent then recovering both carboxyalkyl cellulose and cross-linking agent from the mixture and heat-treating the recovered materials at temperature from about 100° C. to about 200° C. for a time of from about 1 minute to about 600 minutes. The viscosity of carboxyalkyl polysaccharide in a 1.0 weight percent aqueous solution at 25° C. is beneficially from about 1,000 centipoise (cps—or 1,000 mPas) to about 80,000 cps (80,000 mPa·s) and an average degree of substitution suitably from about 0.4 to about 1.2. The cross-linking agent is selected from the group consisting of e.g. chitosan glutamate, diethylenetriamine, chloroacetic acid, 1,4-butylene glycol, ZnCl₂, AlCl₃. The resulting absorbent material has an AUL value at 0.3 psi ranging from 17 to 31.8 g/g and retains at least about 50% of the initial AUL value after aging about 60 days at about 24° C., and at least about 30% relative humidity.

All of the above examples require the use of cross-linkers that are typically petroleum based, and in some cases (e.g., U.S. Pat. No. 5,550,189), high temperature is required for processing. Moreover, the steps disclosed in the prior art are numerous and tend to impede scale-up and commercialization. Thus, there is still a need to provide cellulose-based superabsorbent hydrogels that address the shortcomings of the hydrogels above, specifically cellulose-based superabsorbent hydrogels that are non-toxic and that form instantly after cross-linking in a one-pot synthesis process.

### SUMMARY

In accordance with one aspect, there is provided a superabsorbent hydrogel comprising a negatively charged water-soluble carboxyalkyl polysaccharide cross-linked with negatively charged cellulose nanocrystals in an aqueous medium.

The negatively charged water-soluble carboxyalkyl polysaccharide is an anionic carboxyalkyl cellulose, anionic carboxyalkyl caragenan, anionic carboxyalkyl agar, anionic carboxyalkyl gellan gum or any combination thereof. In one preferred aspect, the anionic carboxyalkyl cellulose is an anionic carboxymethyl cellulose.

The anionic carboxymethyl cellulose has a degree of substitution (DS) of 0.7<DS<1.2, preferably a degree of substitution (DS) of about 0.9.

The anionic carboxymethyl cellulose has a molecular weight (Mw) of about 250,000 Da<Mw<about 900,000 Da, preferably of about 700,000 Da.

The cellulose nanocrystals are substituted with a negative entity comprising sulfate half-ester groups (—SO₃H or —SO₃Na), carboxylates (—COOH or —COONa) or phosphates (O—PO₃H₂ or O—PO₃Na₂).

The cellulose nanocrystals have a crystallinity between about 85% and about 97%, preferably between about 90% and about 97%.

The cellulose nanocrystals have a degree of polymerization (DP) of 90≤DP≤110.

The cellulose nanocrystals have between 3.7 and 6.7 sulphate groups per 100 anhydroglucose units.

The cellulose nanocrystals have aspect ratios between about 10 and about 20.

The cellulose nanocrystals have dimensions between about 5 and about 15 nm in cross-section and between about 100 and about 150 nm in length.

The superabsorbent hydrogel of any one of claims 9 to 17, wherein a mass ratio of CNCs to CMC is between about 0.01 and about 1.

In the superabsorbent hydrogel, a mass ratio of CNCs to CMC is between about 0.01 and about 0.1.

The superabsorbent hydrogel comprises particles have a size of less than 1 mm, preferably between about 200 μm and about 800 μm.

The superabsorbent hydrogel particles comprise an outer shell of polyetheramines, wherein the polyetheramines comprise polyetherdiamines with a Mw between about 600 Da and about 2,000 Da.

The superabsorbent hydrogel has a Free Swell Capacity of at least 30 g/g in saline (0.9% sodium chloride) solution.

In an embodiment, it is provided the use of the superabsorbent hydrogel as described herein in the manufacture of superabsorbent articles.

In accordance with another aspect there is provided a method of producing a superabsorbent hydrogel comprising the steps of mixing a first anionic carboxyalkyl cellulose solution with a second negatively-charged cellulose nanocrystals solution in an aqueous medium, a mass ratio of cellulose nanocrystals to carboxyalkyl cellulose being between about 0.01 and about 1; agitating a resulting mixture for about 1 minute; and drying the superabsorbent hydrogel.

The resulting mixture is left undisturbed for between about 2 hours and about 24 hours prior to proceeding to the drying step.

The drying step comprises spray drying.

Alternatively, the drying step comprises any one of vacuum/oven drying, freeze drying, flash drying, using fluidized bed dryers or belt drying process, followed by a step of comminuting the superabsorbent hydrogel to form superabsorbent hydrogel particles after the drying step.

The method further comprises the step of surface treating the superabsorbent hydrogel particles with polyetheramines.

### DESCRIPTION OF THE DRAWINGS

FIG. 1 shows a cross-sectional schematic view of a cellulose-based superabsorbent hydrogel comprising CMC and CNCs in accordance with one embodiment of the present disclosure.

FIG. 2 shows a process of making the cellulose-based superabsorbent hydrogel comprising CMC and CNCs of FIG. 1 in accordance with one embodiment of the present disclosure.

### DETAILED DESCRIPTION

There is provided a cellulose-based superabsorbent hydrogel comprising negatively-charged, water-soluble polysaccharides and negatively-charged CNCs.

The water-soluble polysaccharides may be any suitable negatively-charged water-soluble carboxyalkyl polysaccharide, such as but not limited to CMC, carboxyalkyl caragenan, carboxyalkyl agar, carboxyalkyl gellan gum or any combination thereof. In a preferred embodiment, the carboxyalkyl polysaccharide is CMC.

CMC is a cellulose ether used in detergents, paint, textile, pulp and paper, oil-drilling, food and other applications. Methods of making CMC are known to those skilled in the art. A cellulose-rich material, such as dissolving pulp or cotton, in form of fibers or powder is suspended in an organic solvent, such as ethanol or isopropanol. An appropriate amount of water and sodium hydroxide is added to convert cellulose into its sodium form—sodium cellulosate. The sodium cellulosate is then reacted with a chloroalkanoic acid, such as monochloroacetic acid, or a salt of the chloroalkanoic acid, such as sodium monochloroacetate, which leads to the substitution of the hydroxyl groups of cellulose for carboxymethyl groups. In theory, all three (3) hydroxyl groups on the anhydroglucose units (AGU) can be substituted which would yield a maximal degree of substitution (DS) value of 3, the term “degree of substitution (DS)” referring to a measure of how many of the three (3) hydroxyl groups (—OH) of the AGU have been substituted for carboxymethyl groups during the carboxymethylating reaction. As used herein, AGU is understood as a pyranose ring that is the building block of the cellulose macromolecule. The pyranose ring consists of a glucose molecule. The pyranose rings are linked together via glycosidic bonds to form long polymer chains and during the formation of the glycosidic bond one molecule of water is eliminated from the glucose molecule.

To reach the maximum (theoretical) DS is extremely difficult for CMC, and because CMC becomes water soluble around a DS of 0.5, most of commercial CMC have a DS of 0.5 to 1.5 which is more economical and technically feasible. CMC having a DS below 0.5 is also commercially available. The chain of CMC can be shortened to reduce the degree of polymerization which in turn reduces the viscosity of the CMC solution. Hydrogen peroxide, sodium hypochlorite or oxygen can be used to cleave the 1-O-4 β glycosidic bond through an oxidative reaction. The resultant CMC is then washed with a mixture of solvent and water before it is dried and comminuted.

In a first embodiment, the CMC according to the present disclosure may have a DS of 0.7<DS<1.2, more preferably a DS of about 0.9, the DS of the CMC being determined using ASTM-D1439-03 (2008). A CMC having 0.7<DS<1.2 is water-swellable and water-soluble. However, a low-substituted CMC, or CMC with DS<0.4 is not soluble in water, but can be solubilized under alkaline conditions.

The CMC according to the present disclosure may have a molecular weight (Mw) of about 250,000<Mw<about 900,000 Da, more preferably a Mw of about 700,000 Da, where Da is equivalent to mass in grams per one mole of a given compound. The CMC may exhibit viscosities (μ) at 25° C. of about 400 cps<μ<about 6000 cps.

The CMC may originally be provided in an aqueous solution having a concentration of CMC in water of about 0.01% to about 1% weight/volume (w/v), more preferably a concentration of about 0.1% (w/v). After the addition of CMC into the aqueous solution, the resulting mixture is subjected to gentle agitation and all CMC is dissolved in water instantaneously. A cross-linker is then introduced and allowed to react with the hydroxyl groups of the CMC, as further described below.

In this embodiment, the cross-linker is the negatively charged CNCs. The CNCs characteristically possess a negative entity on the surface including, but not limited to, sulfate half-ester groups (—SO₃H or —SO₃Na), carboxylates (—COOH or —COONa) or phosphates (O—PO₃H₂ or O—PO₃Na₂). In a preferred embodiment, the CNCs possess sulfate half-ester groups (—SO₃H or —SO₃Na). It is therefore appreciated that no other cross-linker is needed for the cross-linking of CMC with CNCs.

CNCs are generally extracted as a colloidal suspension by (typically sulfuric) acid hydrolysis of lignocellulosic materials, such as bacteria, cotton, wood pulp and the likes. CNCs are comprised of cellulose, a linear polymer of β(1→4) linked D-glucose units, and possess a high degree of crystallinity in the bulk material, while various degrees of order, or in other words different levels of amorphicity, may exist on the surface. The colloidal suspensions of CNCs is characterized as liquid crystalline at a critical concentration 5-7 wt. %, and the chiral nematic organization of CNCs remain unperturbed in films formed upon evaporation.

In an embodiment, the CNCs have a degree of crystallinity between about 85% and about 97%, more preferably between about 90% and about 97% (that is, approaching the theoretical limit of crystallinity of the cellulose chains), which is the ratio of the crystalline contribution to the sum of crystalline and amorphous contributions as determined from original powder X-ray diffraction patterns. Moreover, the CNCs may have a degree of polymerization (DP) of 90≤DP≤110, and between about 3.7 and about 6.7 sulphate groups per 100 anhydroglucose units (AGU).

The CNCs are charged nanoparticles whose dimensions depend on the raw material used in the original extraction process. In one non-limiting embodiment, the CNCs range between about 5 and about 15 nm in cross-section and between about 100 and about 150 nm in length for bleached kraft pulp as raw material resulting in an aspect ratio (defined as the ratio of the length the nanocrystal over its cross section) ranging between 10 and 20. Other dimensions may be suitable in other embodiments.

The CNCs may originally be provided as an aqueous suspension. The CNCs in aqueous suspension may be at a neutral pH, where a counter ion of the sulfate half-ester group is sodium, or alternatively at an acidic pH, where the counter ion of the sulfate half-ester group is hydrogen. A concentration of CNCs in the aqueous suspension may be in the range between about 2% and about 8% by weight (w), preferably between about 4% and about 6% (w). In other embodiments, CNCs in dried form, for instance spray-, air- or freeze-dried may also be used however in this case the CNCs need to be re-dispersed in deionized water under agitation and filtered to eliminate any agglomerates so as to obtain a generally-uniform nano-sized material.

As further discussed below, the water-dissolved CMC in solution is mixed with the CNCs in aqueous suspension for cross-linking the CMC with CNCs and ultimately forming the cellulose-based superabsorbent hydrogel. In this embodiment, the water-dissolved CMC in solution is mixed with the CNCs in aqueous solution for about 1 minute and following mixing the cellulose-based superabsorbent hydrogel is formed within about 10 seconds to about 20 seconds.

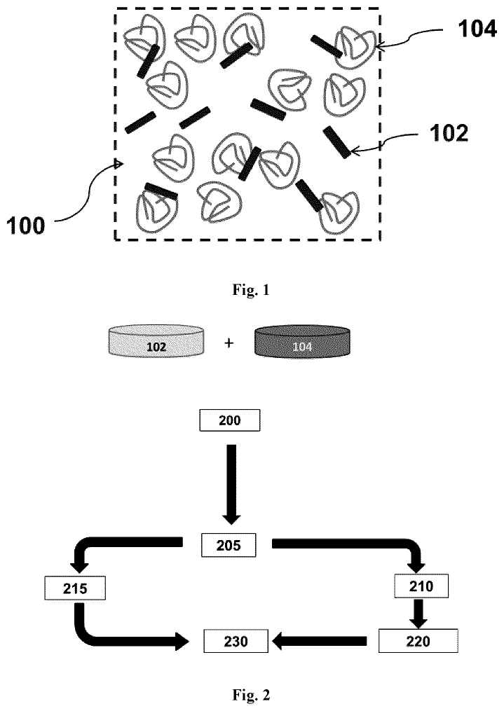

A mass ratio of CNCs to CMC (CNCs:CMC) may be between about 0.01 and about 1, more preferably between about 0.01 and about 0.1. As shown in FIG. 1, in the cellulose-based superabsorbent hydrogel 100 the CNCs 102 are present in the hydrogel 100 at low concentrations 0.1 wt. % or lower, leading to a uniformly distributed and percolated network of CNCs 102 where CMC 104 is physically adsorbed onto the CNCs 102 by a polymer bridging mechanism leading to excellent FSC responses, typically greater than 40 g/g.

In an embodiment, the CMC 104 is therefore used as the absorbing polymer which is being cross-linked by the CNCs. The ability of the cellulose-based superabsorbent hydrogels so formed, as further described below, to absorb large amounts of water (as indicated by FSC>40 g/g) arises from cross-linking the CMC using the negatively-charged CNCs, and their resistance to dissolution also arises from the cross-linking between the network chains done by the negatively charged CNCs. It is appreciated that due to the nature of the CMC and CNCs, the cellulose-based superabsorbent hydrogel is non-toxic, recyclable and potentially biodegradable.

With further reference to FIG. 2, there is provided a process of making the cellulose-based superabsorbent hydrogels according to the present disclosure. CMC 104 and CNCs 102 in aqueous solutions are mixed 200. As discussed previously, the CMC may be provided in an aqueous solution having a concentration of CMC of about 0.01% to about 1% (w/v), more preferably a concentration of about 0.1% (w/v), the CMC being completely dissolved in the solution. The CNCs may be provided as an aqueous suspension at a neutral pH or alternatively at an acidic pH and at a concentration between about 2% and about 8% (w), preferably between about 4% and about 6% (w).

In a first step 200, the CNCs in aqueous suspension are mixed with the CMC aqueous solution to form a mixture. Because the CNCs act as cross-linker, no other cross-linker is needed for the cross-linking of CMC with CNCs. As discussed above, the mass ratio CNCs:CMC may be between about 0.01 and about 1, more preferably between about 0.01 and about 0.1. The CNCs may be added in bulk, or preferably gradually, to the CMC aqueous solution and agitation is continuously employed after the CNCs addition. The agitation may be performed manually by rapidly agitating the mixture for about 1 minute. The agitation is then discontinued as the mixture stops behaving as a viscous liquid and starts to resemble a highly viscous gel, which occurs within about 10 seconds to about 20 seconds. It is appreciated that the gelling behavior changes according to (1) the CMC concentration of the solution and (2) the CNCs:CMC mass ratio. Higher CNCs:CMC mass ratios or CMC concentrations result in harder hydrogels while lower CNCs:CMC mass ratios or CMC concentrations results in softer hydrogels. The resulting superabsorbent hydrogel has a pH between about 4 and about 6. Once the superabsorbent hydrogel is formed after first step 200, it is left undisturbed for a period of time between about 1 hour and about 24 hours before proceeding to the subsequent step.

In a further step 205, the superabsorbent hydrogel is de-watered before proceeding to step 210 in which the superabsorbent hydrogel is dried to produce a solid material, specifically a superabsorbent hydrogel film or particulates. Various drying processes may be used in step 210, such as but not limited to vacuum/oven drying, freeze drying, flash drying, using fluidized bed dryers or belt drying process. In one embodiment, vacuum/oven drying is performed at a temperature of between about 50° C. and about 70° C., more preferably at a temperature of about 55° C.

In a further step 220, the resulting dried hydrogel film is comminuted to obtain dried particle with a specific particle size depending on application requirements. The particle size will usually be <1 mm, more preferably between about 200 μm and about 800 μm, but smaller is possible as well.

Alternatively, in a further embodiment, the drying and comminuting steps 210 and 220 may be substituted for a spray-drying step 215 in which the particle size is determined and controlled by the spray-drying conditions, thereby alleviating the need for comminution.

In a further optional step 230, the dried particles may optionally be surface cross-linked. This optional step consists in modifying the surface of the particles with an additional cross-linking agent resulting in a highly cross-linked shell and increased rigidity leading to enhanced water absorption against pressure, and consequently enhanced permeability of the hydrogel. This optional fifth step may consist in applying polyetheramines, more preferably diamines based on the core polyether backbone structure. Examples of suitable polyetherdiamines include but are not limited to the commercially available Jeffamines consisting of polyether diamines based on a predominantly PEG backbone, with a Mw between about 600 Da and about 2,000 Da.

It is appreciated that, in this embodiment, the process described above is easily scalable, that is it can easily be adapted for small or large operational volumes, allows for rapid (in the order of a minute) cross-linking of CMC with CNCs, and is a one-pot process, that is the entire process described above may be performed within the same reactor.

### Examples

A CMC solution is prepared by dissolving 0.5 g of CMC with a MW of 700,000 Da and a DS of 0.9 in 100 mL of deionized water to make a 0.5% (w/v) CMC solution. The dissolving process is performed by shaking CMC and water in an incubator shaker (innova 4080, New Brunswick scientific) at 350 rpm for at least 18 hours to obtain a dissolved CMC solution. A CNC suspension, H-form or Na-form, at 4% (w) is first sonicated at about 2500 J/g and added to the CMC solution at a mass ratio CNCs:CMC ranging from 0.01 to 1, then rapidly shaken by hand for a minute and left undisturbed in a closed glass jar for 1 day at room temperature. In a laboratory setting, the CNC:CMC mixture is either freeze dried or vacuum/oven dried at 55° C. The vacuum/oven dried films are then pre-broken by hand to reduce the film to small pieces then milled using a four knife blender followed by passing these flakes through a burr mill grinder while freeze dried hydrogel is grated using a cheese grater. The powder is then tested for FSC in saline (Standard procedure: NWSP 240.0.R2). This procedure refers to the absorption capacity of the hydrogel particles without pressure. The sample is weighed and placed in a bag then submerged in a saline solution (0.9% NaCl) to be absorbed and allowed to soak for a defined soaking period, after which the bag is removed. Excess fluid is allowed to drip away and the sample is weighed to determine the amount of saline solution absorbed. The results of the testing are set forth in Table 1 below.

TABLE 1
Free swell capacity of CNC-CMC hydrogels prepared at different conditions

| | CMC | CNC | [CMC] | CNC:CMC | | FSC in |
|---|---|---|---|---|---|---|
| Sample | (Mw - DS) | (counter-ion) | % (w/v) | mass ratio | Drying process | saline (g/g) |
| A | 700k - 0.9 | H-Form | 0.5 | 0.01 | Oven drying | 56.8 ± 1.6 |
| B | 700k - 0.9 | H-Form | 0.5 | 0.1 | Oven drying | 68.7 ± 1.7 |
| C | 700k - 0.9 | H-Form | 0.5 | 0.5 | Oven drying | 49.4 ± 0.03 |
| D | 700k - 0.9 | H-Form | 0.5 | 1 | Oven drying | 36.8 ± 2.0 |
| E | 700k - 0.9 | Na-Form | 0.5 | 0.01 | Oven drying | 45.4 ± 5.6 |
| F | 700k - 0.9 | Na-Form | 0.5 | 0.1 | Oven drying | 68.0 ± 1.0 |
| G | 700k - 0.9 | Na-Form | 0.5 | 0.5 | Oven drying | 54.8 ± 0.02 |
| A1 | 700k - 0.9 | H-Form | 0.5 | 0.01 | Freeze drying | 32.3 ± 2.6 |
| B1 | 700k - 0.9 | H-Form | 0.5 | 0.1 | Freeze drying | 47.6 ± 3.0 |
| C1 | 700k - 0.9 | H-Form | 0.5 | 0.5 | Freeze drying | 60.6 ± 0.1 |
| D1 | 700k - 0.9 | H-Form | 0.5 | 1 | Freeze drying | 48.2 ± 0.2 |
| E1 | 700k - 0.9 | Na-Form | 0.5 | 0.01 | Freeze drying | 31.8 ± 0.3 |
| F1 | 700k - 0.9 | Na-Form | 0.5 | 0.1 | Freeze drying | 49.5 ± 7.6 |
| G1 | 700k - 0.9 | Na-Form | 0.5 | 0.5 | Freeze drying | 60.5 ± 2.5 |
| H1 | 700k - 0.9 | Na-Form | 0.5 | 1 | Freeze drying | 48.6 ± 1.0 |

As can be shown from Table 1 above, the superabsorbent hydrogel according to the present disclosure can have FSC values exceeding 60 g/g in saline, which is significant for various hygiene and other applications.

While the present description has been described in connection with specific embodiments thereof, it will be understood that it is capable of further modifications and this application is intended to cover any variations, uses, or adaptations, including such departures from the present disclosure as come within known or customary practice within the art and as may be applied to the essential features hereinbefore set forth, and as follows in the scope of the appended claims.

1. A superabsorbent hydrogel comprising a negatively charged water-soluble carboxyalkyl polysaccharide cross-linked with negatively charged cellulose nanocrystals in an aqueous medium.

2. The superabsorbent hydrogel of claim 1, wherein the negatively charged water-soluble carboxyalkyl polysaccharide is an anionic carboxyalkyl cellulose, an anionic carboxyalkyl carrageenan, an anionic carboxyalkyl agar, an anionic carboxyalkyl gellan gum or a combination thereof.

3. The superabsorbent hydrogel of claim 2, wherein the anionic carboxyalkyl cellulose is an anionic carboxymethyl cellulose.

4. The superabsorbent hydrogel of claim 3, wherein the anionic carboxymethyl cellulose has a degree of substitution (DS) of 0.7<DS<1.2.

5. The superabsorbent hydrogel of claim 4, wherein the anionic carboxymethyl cellulose has a degree of substitution (DS) of about 0.9.

6. The superabsorbent hydrogel of claim 4, wherein the anionic carboxymethyl cellulose has a molecular weight (Mw) of about 250,000 Da<Mw<about 900,000 Da.

7. The superabsorbent hydrogel of claim 6, wherein the anionic carboxymethyl cellulose has a molecular weight (Mw) of about 700,000 Da.

8. The superabsorbent hydrogel of claim 1, wherein the cellulose nanocrystals are substituted with a negative entity comprising sulfate half-ester groups, carboxylates or phosphates.

9. The superabsorbent hydrogel of claim 8, wherein the cellulose nanocrystals are substituted with sulfate half-ester groups.

10. The superabsorbent hydrogel of claim 1, wherein the cellulose nanocrystals have a crystallinity between about 85% and about 97%.

11. The superabsorbent hydrogel of claim 10, wherein the cellulose nanocrystals have a crystallinity between about 90% and about 97%.

12. The superabsorbent hydrogel of claim 1, wherein the cellulose nanocrystals have a degree of polymerization (DP) of 90≤DP≤110.

13. The superabsorbent hydrogel of claim 1, wherein the cellulose nanocrystals have between 3.7 and 6.7 sulphate groups per 100 anhydroglucose units.

14. The superabsorbent hydrogel of claim 9, wherein the cellulose nanocrystals have aspect ratios between about 10 and about 20.

15. The superabsorbent hydrogel of claim 14, wherein the cellulose nanocrystals have dimensions between about 5 and about 15 nm in cross-section and between about 100 and about 150 nm in length.

16. The superabsorbent hydrogel of claim 1, wherein a mass ratio of CNCs to CMC is between about 0.01 and about 1.

17. The superabsorbent hydrogel of claim 16, wherein the mass ratio of CNCs to CMC is between about 0.01 and about 0.1.

18. The superabsorbent hydrogel of claim 1, wherein the superabsorbent hydrogel comprises particles having an outer shell of cross-linked polyetheramines.

19. The superabsorbent hydrogel of claim 18, wherein the polyetheramines comprise polyetherdiamines with a Mw between about 600 Da and about 2,000 Da.

20. (canceled)

21. A method of producing superabsorbent hydrogel comprising the steps of:
mixing a first anionic carboxyalkyl cellulose solution with a second cellulose nanocrystals solution in an aqueous medium, a mass ratio of cellulose nanocrystals to carboxyalkyl cellulose being between about 0.01 and about 1;
agitating a resulting mixture for about 1 minute to form the superabsorbent hydrogel; and
drying the superabsorbent hydrogel.

22-36: (canceled)
